(19) United States
(12) Patent Application Publication
(10) Pub. No.: US 2020/0324847 A1
(43) Pub. Date: Oct. 15, 2020

(54) CONVERTIBLE TWO-WHEELER

(71) Applicant: Pascher + Heinz GmbH, Munchen (DE)

(72) Inventors: Reinhard Pascher, Salmdorf (DE); Tao Schirrmacher, Munchen (DE)

(73) Assignee: Pascher + Heinz GmbH, Munchen (DE)

(21) Appl. No.: 16/845,310

(22) Filed: Apr. 10, 2020

(30) Foreign Application Priority Data
Apr. 10, 2019 (DE) 10 2019 002 631.4

(51) Int. Cl. B62K 13/08; B62M 3/00

(52) U.S. Cl. CPC B62K 13/08; B62M 3/00

(57) ABSTRACT

A convertible two-wheeler which can be converted from a balance bike to a bicycle without tools by hooking and locking a crank assembly into two receptacles of the frame. The crank assembly has a fastening element that can be connected in a form-fitting manner to the two receptacles on the frame, the fastening element consisting of two elements which are interconnected by means of a pivot bearing and between which the bottom bracket is clamped, the two elements being braced against one another by means of an eccentric lever and the length of the eccentric lever being adjustable.

### REFERENCE TO RELATED APPLICATION

This application claims priority to German application 10 2019 002 631.4, filed Apr. 10, 2019, the entire disclosure of which is incorporated herein by reference.

### FIELD OF THE INVENTION

The invention relates to a convertible two-wheeler.

### BACKGROUND

GB 598 235 A discloses a convertible two-wheeler with a frame and two wheels that are rotatably mounted on the frame, one of which can be steered with a handlebar. Two receptacles are attached to the frame as well as a crank assembly having a fastening element that can be connected in a form-fitting manner to the two receptacles on the frame. Both receptacles have the shape of a cylindrical rod and are held at a distance from the frame by protrusions. The fastening element has a depression in the region of one end, which depression is adapted to the shape of the cylindrical rod. A bottom bracket for crank arms is attached to the fastening element.

U.S. Pat. No. 583 022 A discloses a convertible bicycle with a removable crank assembly that is attached to the frame by means of two receptacles. A first receptacle is attached in a horizontal region of the frame, and a second receptacle is attached to a vertically inclined region of the frame.

Convertible bicycles with a removable crank assembly are also known from U.S. Pat. No. 1 907 645 A, FR 533 655 A, US 2018 0 050 760 A1, and US 2014 0 084 564 A1.

DE 32 444 661 A1 describes a convertible two-wheeler that can be used as a scooter, balance bike, or bicycle. In its basic function as a scooter with a handlebar and two wheels that are rotatably mounted on a frame, a draisienne-type balance bike can be created by adding a height-adjustable and swiveling saddle and by adjusting the height of the handlebar, and a bicycle can be realized by also adding a crank drive. However, the installation and removal of the corresponding parts requires the use of tools.

### SUMMARY OF THE INVENTION

It is the object of the invention to improve the convertible two-wheeler mentioned at the outset in such a way that it can be converted in a simple manner without prior knowledge and, in particular, without tools.

This object is achieved by the features specified in the claim. Advantageous embodiments and developments of the invention can be found in the dependent claims.

### BRIEF DESCRIPTION OF THE FIGURES

FIG. 1 is a side view of the two-wheeler of the invention in an embodiment as a balance bike;

FIG. 2 is a side view of the two-wheeler of the invention in an embodiment as a bicycle;

FIG. 3 shows an enlarged partial view of the crank assembly as it approaches the frame;

FIG. 4 is a view similar to that of FIG. 3 in another intermediate position;

FIG. 5 is an enlarged, partially cutaway view of the fastening element of the invention;

FIG. 6 shows the fully installed state, with only the projection 23 of the latch 22 still being in the open position;

FIG. 7 shows a schematic side view of another embodiment of a crank assembly;

FIG. 8 shows a perspective oblique view of the crank assembly of FIG. 7; and

FIG. 9 shows a side view of the crank assembly of FIGS. 7 and 8 in the disassembled state.

### DETAILED DESCRIPTION OF PREFERRED EMBODIMENTS

The basic concept of the invention is to fasten a crank assembly to the frame of the two-wheeler by simply hooking it in. If a drive chain or a drive belt is attached, a bicycle can be created from a balance bike in just a few steps.

In one embodiment of the invention, two receptacles are attached to the frame, and a crank assembly is provided which has a fastening element that can be connected in a form-fitting manner to the two receptacles on the frame. The crank assembly contains the usual crank arms, which are connected to one another by means of a shaft, as well as a drive wheel, which can be a sprocket wheel or a drive belt wheel, and the abovementioned fastening element, which can be inserted into said receptacles.

According to a development of the invention, one of the receptacles is attached to a horizontal region of the frame, and the other receptacle is attached to a vertically inclined region of the frame, so that horizontally and vertically acting forces of the crank assembly are conducted into the frame.

According to another development of the invention, both receptacles have the shape of a rod and are each held at a distance from the frame by protrusions. The fastening element can thus be held stably between the rods and the frame.

According to another embodiment of the invention, at least one receptacle is an opening in the frame into which the fastening element can be hooked.

In the region of one end, the fastening element is embodied such that it can be attached to the frame. This can be done by means of the opening in the frame or also on the aforementioned rod. In the latter case, the fastening element has a depression in the region of one end, the shape of which depression is adapted to the rod. The depression is such that the fastening element can be hooked on the rod and swiveled there. At the opposite region of the fastening element, a recess is provided which is dimensioned such that it is able to receive the rod of the other receptacle. A displaceable latch is provided in this recess that can be inserted between the frame and the rod in order to lock the fastening element on the frame. This latch can also be biased into a closed position by means of a spring.

In general, the receptacles are arranged on the frame in such a way that, after the fastening element has been hooked in at the first hooking point, the fastening element is swiveled in such a way that the distance between the drive wheel of the crank assembly and the driven wheel increases, so that a drive chain or toothed belt is tensioned.

The latch preferably has a run-up chamfer in order to ensure better and simple tensioning of the fastening element.

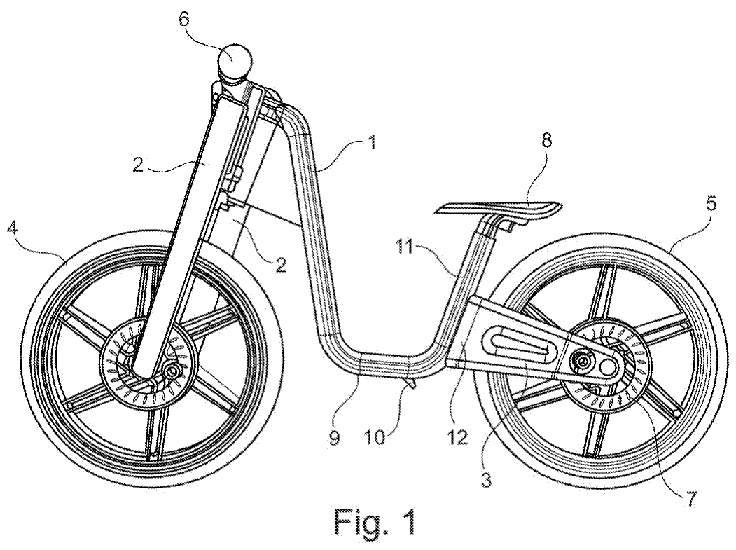

Firstly, FIG. 1 shows substantially a conventional balance bike with a frame 1, a front wheel fork 2, a rear wheel swing arm 3, a front wheel 4, and a rear wheel 5. Furthermore, the balance bike has the usual handlebar 6, brake discs 7, and a saddle 8.

To implement the invention, a front receptacle 10 is provided at the lower horizontal region 9 of the frame 1, and a second receptacle 12 is provided at the rear, approximately vertically inclined region 11 of the frame 1, the latter being shown only in dashed lines because it is concealed in the figure by the rear wheel swing arm 3.

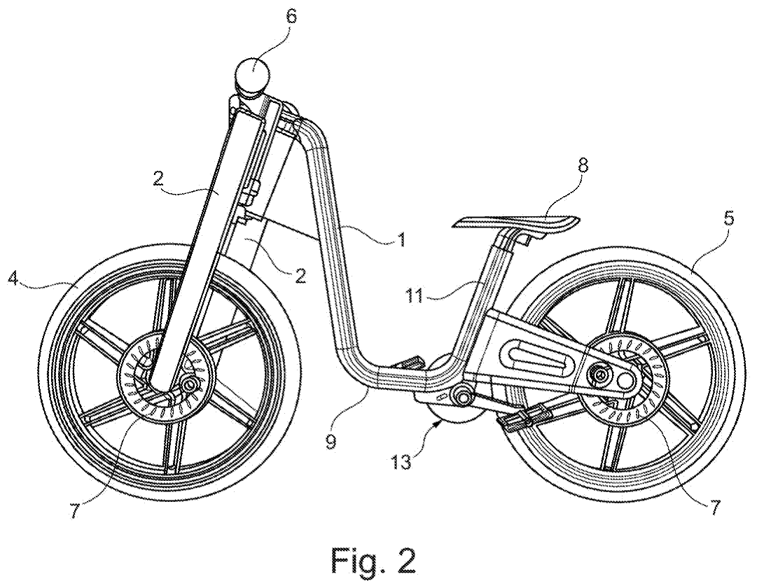

FIG. 2 clearly shows that a crank assembly 13 is attached to these two receptacles 10 and 12 when the balance bike is converted into a bicycle. As will readily be understood, a drive chain or a drive belt must also be placed between the crank assembly 13 and the driven rear wheel 5. It should also be pointed out that, in a preferred embodiment of the invention, only one rear wheel swing arm 3 is provided, specifically on the side facing away from the crank assembly 13. This enables the crank assembly 13 to be installed in an especially simple manner together with the drive chain or drive belt.

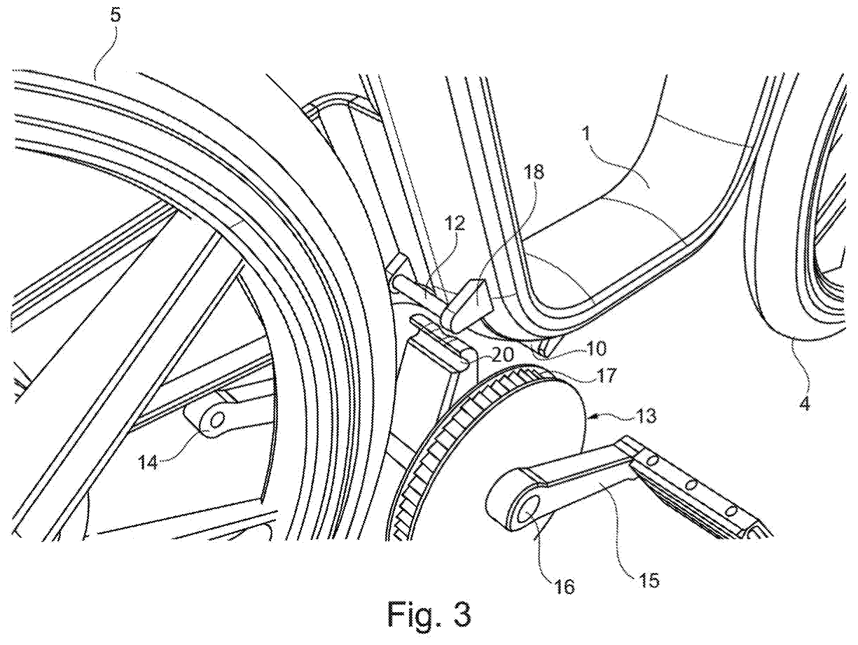

FIG. 3 illustrates the installation of the crank assembly 13 on the frame 1. The crank assembly 13 contains the usual crank arms 14 and 15, which are attached to a common shaft 16. Furthermore, it has a drive wheel 17 that is connected in a rotationally fixed manner to the shaft 16. Finally, a fastening element 19 is connected to the shaft 16, particularly in such a way that it can be swiveled on the shaft 16. As will be explained further below, the fastening element 19 also contains the usual bottom bracket of a bicycle drive.

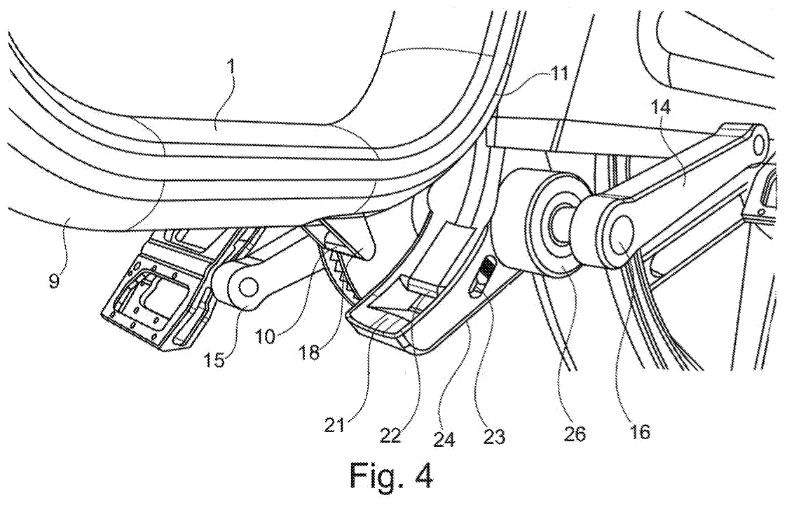

To install the crank assembly 13, the fastening element 19 is pushed between the rear vertical region 11 of the frame 1 and the rod 12 such that the depression 20 engages over the rod 12. The fastening element 19 can then be swiveled together with the entire crank assembly 13 about the axis of the rod 12, so that the other end of the fastening element approaches the front receptacle 10, as is shown in FIG. 4.

In FIG. 4, the fastening element, with its depression 20, is already hooked into the second rod 12 and swiveled in the direction of the front wheel 4. At its other end that is situated opposite the depression 20, the fastening element 19 has a recess 21 that is sufficiently large that it can completely accommodate the front rod 10. The side of the fastening element 19 facing toward the frame 1 is adapted to the shape of the frame, so that the fastening element 19 conforms to the contour of the underside of the frame. Adjoining the recess 21 is a displaceable latch 22 that can engage in the gap between the rod 10 of the front receptacle and the underside of the frame 1 in order to fix the fastening element 19 to the frame 1. To move the latch 22, lateral projections 23 are provided which protrude through an opening 23 in the side wall and are thus accessible from the outside. For the purpose of fixation, the crank assembly 13 is swiveled together with the fastening elements 19 about the axis of the second rod 12 until the fastening element 19 comes to rest against the frame 1 and the front receptacle 10 comes to lie completely in the recess 21. The latch 22 is then moved in order to fix the entire unit to the frame 1.

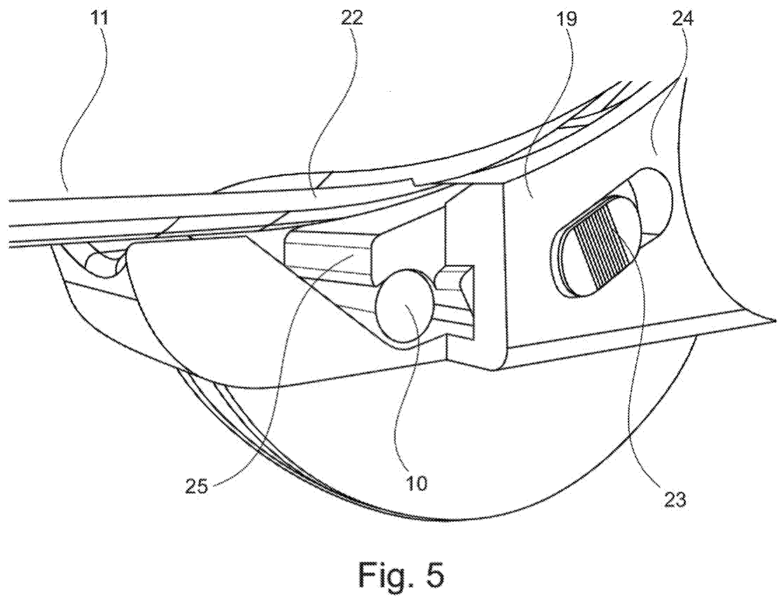

It can be seen from FIG. 4 but particularly from FIG. 5 as well that the latch 22 has a chamfer 25 on its front edge that facilitates sliding on the counter-element, such as on the rod 10 or part of the frame, during fastening.

FIG. 5 shows the fastening element 19 more clearly in the installed state, in which the latch 22 is advanced so far that it engages over the rod 10. As can be seen from FIG. 5, a front tip of the latch 22 is sufficiently long as to engage around the rod 10 in the inserted state beyond a vertical center line, thus preventing an unintentional release of the latch 22. It is thus possible to achieve elastic bracing of the latch 22 and fastening element 19 by means of the material properties of the fastening element 19 and latch 22. In addition, the latch 22 can also be pressed into the closed position by a spring, thus securing the closed position.

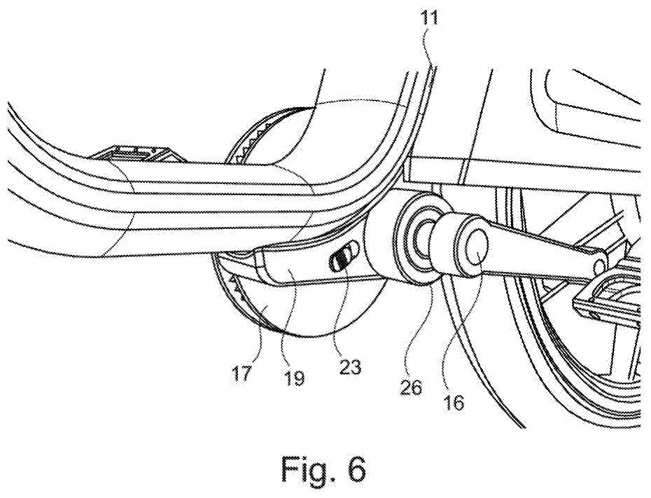

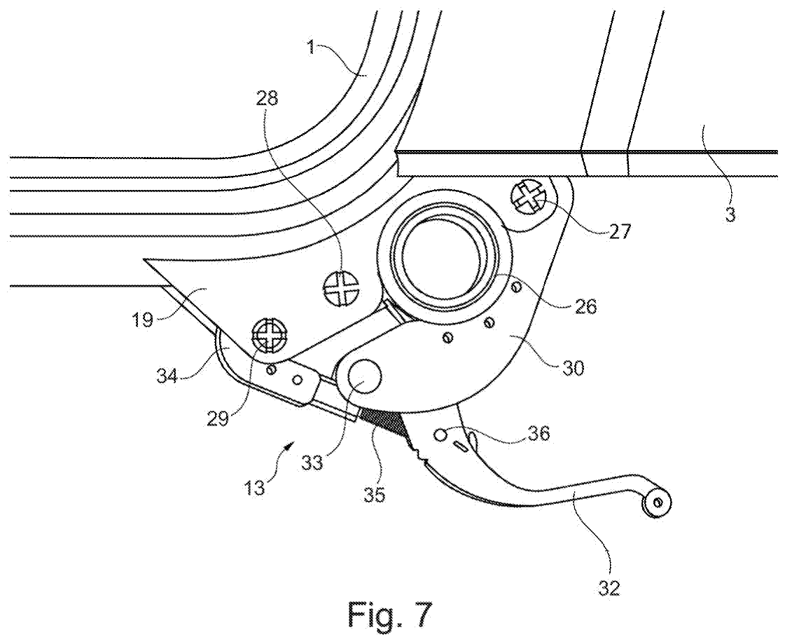

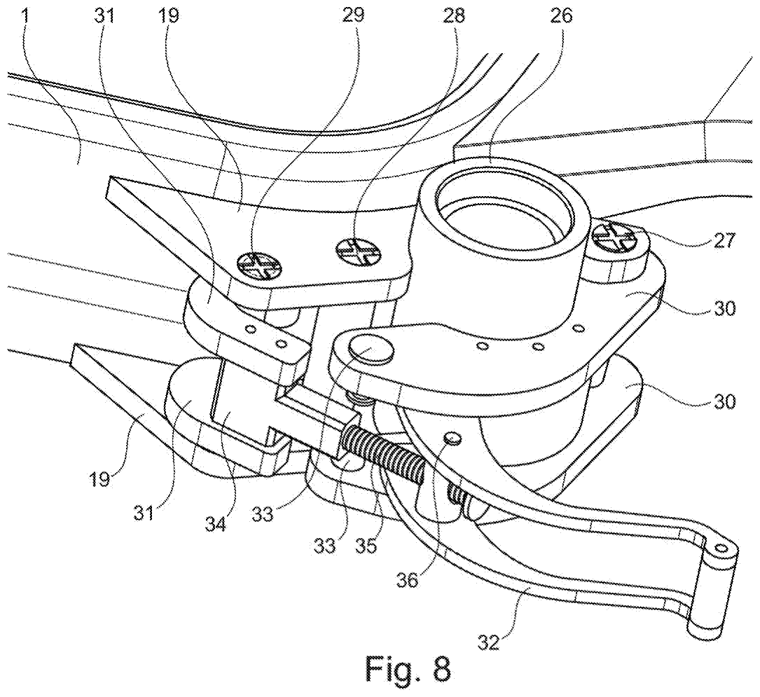

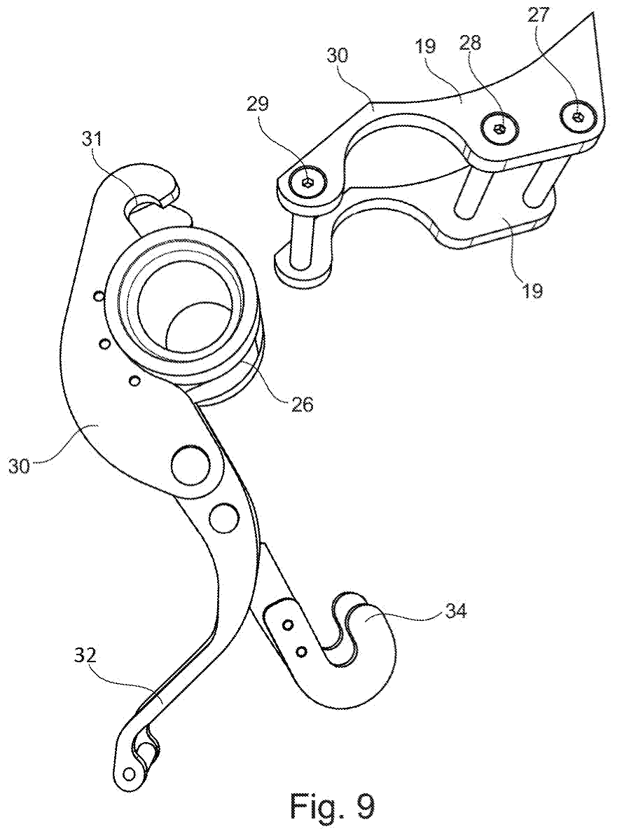

In the embodiment of FIG. 7-9, the crank assembly can generally be opened so that the bottom bracket 26 can be removed separately. The crank assembly has the fastening element 19, which can be fastened to the frame 1 in the same manner as in the embodiments of FIG. 2-6. The fastening element 19 consists of two discs arranged parallel to one another and interconnected by screw bolts 27, 28, and 29. The fastening element 19 has an approximately semicircular recess into which the bottom bracket 26 is inserted. A second fastening element 30 also has an approximately semicircular recess for the bottom bracket. It can be hooked on the screw bolt 29 by means of a hook 31 and swiveled about the axis thereof.

A pivot bearing 33 for a tension lever 32 is provided on the end of the second fastening element 30 situated opposite the hook 31. Eccentrically to the pivot bearing 33, a hook 34 is attached to the tension lever 32 by means of a pivot bearing 36 and can engage in the screw bolt 27. The length of this hook 34 can be adjusted by means of a screw thread 35. If the hook 34 is hooked into the screw bolt 27 and then the tension lever 32 is swiveled in the direction of the second fastening element 30, the two fastening elements 19 and 30 are braced against one another and thus against the bottom bracket 26. The bottom bracket 26 is then fixed to the frame 1. The arrangement of the screw bolts 27 of the bottom bracket 36 and pivot bearing 33 relative to one another is configured such that the tension lever 32 assumes a so-called dead center position in the closed position, whereby the entire unit is also securely locked.

1. A convertible two-wheeler comprising:
a frame;
two wheels that are rotatably mounted on the frame, one of which can be steered with a handlebar;
two receptacles being attached to the frame; and
a crank assembly which has a fastening element that can be connected in a form-fitting manner to the two receptacles on the frame;
wherein the fastening element consists of two elements which are interconnected by means of a pivot bearing and between which a bottom bracket is clamped, the two elements being braced against one another by means of an eccentric lever, and wherein the length of the eccentric lever is adjustable.

2. The convertible two-wheeler as set forth in claim 1, characterized in that a first receptacle is attached to a horizontal region of the frame and a second receptacle is attached to a vertical, inclined region of the frame.

3. The convertible two-wheeler as set forth in claim 1, characterized in that both receptacles have the shape of a cylindrical rod and are held at a distance from the frame by protrusions.

4. The convertible two-wheeler as set forth in claim 3, characterized in that the fastening element has a depression in the region of one end, which depression is adapted to the shape of the cylindrical rod.

5. The convertible two-wheeler as set forth in claim 4, characterized in that the fastening element, in the region of a second end, has a recess that is designed in terms of its size and shape to accommodate the front rod, the fastening element having a displaceable latch that can be inserted between the frame and the rod.

6. The convertible two-wheeler as set forth in claim 5, characterized in that the latch has a run-up chamfer on its edge facing toward the rod.

7. The convertible two-wheeler as set forth in claim 6, characterized in that the latch is biased by a spring into a closed position.

8. The convertible two-wheeler as set forth in claim 1, characterized in that bottom brackets for crank arms are attached to the fastening element.

9. The convertible two-wheeler as set forth in claim 2, characterized in that both receptacles have the shape of a cylindrical rod and are held at a distance from the frame by protrusions.

10. The convertible two-wheeler as set forth in claim 9, characterized in that the fastening element has a depression in the region of one end, which depression is adapted to the shape of the cylindrical rod.

11. The convertible two-wheeler as set forth in claim 10, characterized in that the fastening element, in the region of a second end, has a recess that is designed in terms of its size and shape to accommodate the front rod, the fastening element having a displaceable latch that can be inserted between the frame and the rod.

12. The convertible two-wheeler as set forth in claim 11, characterized in that the latch has a run-up chamfer on its edge facing toward the rod.

13. The convertible two-wheeler as set forth in claim 12, characterized in that the latch is biased by a spring into a closed position.
